(19) United States
(12) Patent Application Publication
(10) Pub. No.: US 2016/0078191 A1
(43) Pub. Date: Mar. 17, 2016

(54) REAL-TIME BIOMETRIC MONITORING AND ALERT GENERATION

(71) Applicant: salesforce. com, inc., San Francisco, CA (US)

(72) Inventors: John Rey Casimiro, Chicago, IL (US); Brian Tomas Jensen, Elgin, IL (US); Bryan John Burke, Denver, CO (US); David Yakir, Chicago, IL (US); Juan Paolo V. Inton, Hoffman Estates, IL (US); Michael A. Salem, Chicago, IL (US); Raj Rajen, Ann Arbor, MI (US); Philip Roger Bruni, Naperville, IL (US)

(21) Appl. No.: 14/705,207

(22) Filed: May 6, 2015

Related U.S. Application Data
(60) Provisional application No. 62/051,413, filed on Sep. 17, 2014.

(51) Int. Cl. G06F 19/00

(52) U.S. Cl. CPC G06F 19/3418; G06F 19/3431

(57) ABSTRACT

System and methods are described for real-time biometric monitoring and alert generation. A system may receive biometric data from a mobile device associated with a patient, and may identify a rule defined by a clinician. The system may generate alert data corresponding to a portion of the biometric data in response to determining that the portion of the biometric data satisfies the rule, and the alert data may be transmitted to a device associated with the clinician.

### CROSS REFERENCE TO RELATED APPLICATION

This application claims the benefit of priority of U.S. Provisional Patent Application No. 62/051,413 entitled “REAL-TIME BIOMETRIC MONITORING AND ALERTS”, by John Rey Casimiro et al., filed Sep. 17, 2014, the contents of which are hereby incorporated by reference herein in their entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever.

### TECHNICAL FIELD

One or more implementations relate to biometric data monitoring, and more specifically to generating alerts for biometric data based on clinician-defined rules.

### BACKGROUND

“Cloud computing” services provide shared resources, software, and information to computers and other devices upon request or on demand. Cloud computing typically involves the over-the-Internet provision of dynamically-scalable and often virtualized resources. Technological details can be abstracted from end-users, who no longer have need for expertise in, or control over, the technology infrastructure “in the cloud” that supports them. In cloud computing environments, software applications can be accessible over the Internet rather than installed locally on personal or in-house computer systems. Some of the applications or on-demand services provided to end-users can include the ability for a user to create, view, modify, store and share documents and other files. As an example, such environments are applicable to the field of telemedicine to facilitate collection of medical data from patients for subsequent management and analysis by teams of clinicians.

### BRIEF DESCRIPTION OF THE DRAWINGS

The included drawings are for illustrative purposes and serve to provide examples of possible structures and operations for the disclosed inventive systems, apparatus, methods and computer-readable storage media. These drawings in no way limit any changes in form and detail that may be made by one skilled in the art without departing from the spirit and scope of the disclosed implementations.

FIG. 1A shows a block diagram of an example environment in which an on-demand database service can be used according to some implementations.

FIG. 1B shows a block diagram of example implementations of elements of FIG. 1A and example interconnections between these elements according to some implementations.

FIG. 2A shows a system diagram of example architectural components of an on-demand database service environment according to some implementations.

FIG. 2B shows a system diagram further illustrating example architectural components of an on-demand database service environment according to some implementations.

FIG. 3 illustrates an exemplary data model of an application for real-time biometric monitoring according to some implementations.

FIG. 4 illustrates an exemplary application sitemap for real-time biometric monitoring according to some implementations.

FIG. 5A shows an illustrative user interface for accessing and reviewing patient data for a group of patients according to some implementations.

FIG. 5B shows an illustrative user interface for accessing and reviewing patient data for a specific patient according to some implementations.

FIG. 5C shows an illustrative user interface for creating rules for generating alerts according to some implementations.

FIG. 6A shows an illustrative user interface that includes a health-related message for a patient to view with a portable device according to some implementations.

FIG. 6B shows an illustrative user interface that includes biometric data for a patient to view with a portable device according to some implementations.

FIG. 6C shows an illustrative user interface that includes additional biometric data for a patient to view with a portable device according to some implementations.

FIG. 7 is a flow diagram illustrating a method for real-time biometric monitoring and alert generation according to some implementations.

FIG. 8 is a flow diagram illustrating a method for defining rules and processing alert data according to some implementations

### DETAILED DESCRIPTION

Examples of systems, apparatus, computer-readable storage media, and methods according to the disclosed implementations are described in this section. These examples are being provided solely to add context and aid in the understanding of the disclosed implementations. It will thus be apparent to one skilled in the art that the disclosed implementations may be practiced without some or all of the specific details provided. In other instances, certain process or method operations, also referred to herein as “blocks,” have not been described in detail in order to avoid unnecessarily obscuring the disclosed implementations. Other implementations and applications also are possible, and as such, the following examples should not be taken as definitive or limiting either in scope or setting.

In the following detailed description, references are made to the accompanying drawings, which form a part of the description and in which are shown, by way of illustration, specific implementations. Although these disclosed implementations are described in sufficient detail to enable one skilled in the art to practice the implementations, it is to be understood that these examples are not limiting, such that other implementations may be used and changes may be made to the disclosed implementations without departing from their spirit and scope. For example, the blocks of the methods shown and described herein are not necessarily performed in the order indicated in some other implementations. Additionally, in some other implementations, the disclosed methods may include more or fewer blocks than are described. As another example, some blocks described herein as separate blocks may be combined in some other implementations. Conversely, what may be described herein as a single block may be implemented in multiple blocks in some other implementations. Additionally, the conjunction “or” is intended herein in the inclusive sense where appropriate unless otherwise indicated; that is, the phrase “A, B or C” is intended to include the possibilities of “A,” “B,” “C,” “A and B,” “B and C,” “A and C” and “A, B and C.”

The implementations described herein enable real-time monitoring of a patient's biometric data using a mobile device (such as a wearable device) to enhance preventative treatment. The implementations further enhance the patient experience by permitting health/medical professionals (collectively referred to as “clinicians”) to send alerts and messages to the patient's mobile device in response to detecting a predetermined condition being met based on the monitored biometric data.

The implementations described herein allow clinicians and patients to pro-actively monitor vitals in real time in order to predict and track potential health issues. The implementations may accordingly empower individuals to proactively monitor their health in partnership with a clinician to reduce overall healthcare costs by predicting health issues before they occur. Moreover, the implementations advantageously establish real-time updates and a link between clinicians and patients that may be cheaper, faster, and more intuitive than conventional medical tracking devices.

The implementations described herein may also help mitigate health issues and unnecessary costs associated with health care inefficiencies. Such costs may be avoided by proactively monitoring a patient's progress in real-time (e.g., after the patient is sick, has surgery, etc.), by setting up alert notifications to immediately notify the clinician when the patient is not following the plan prescribed to him/her, and by decreasing the need for onsite assessments. In some implementations, the patient may receive notification that doctor is accessing/reviewing his/her biometric data.

### I. Example System Overview

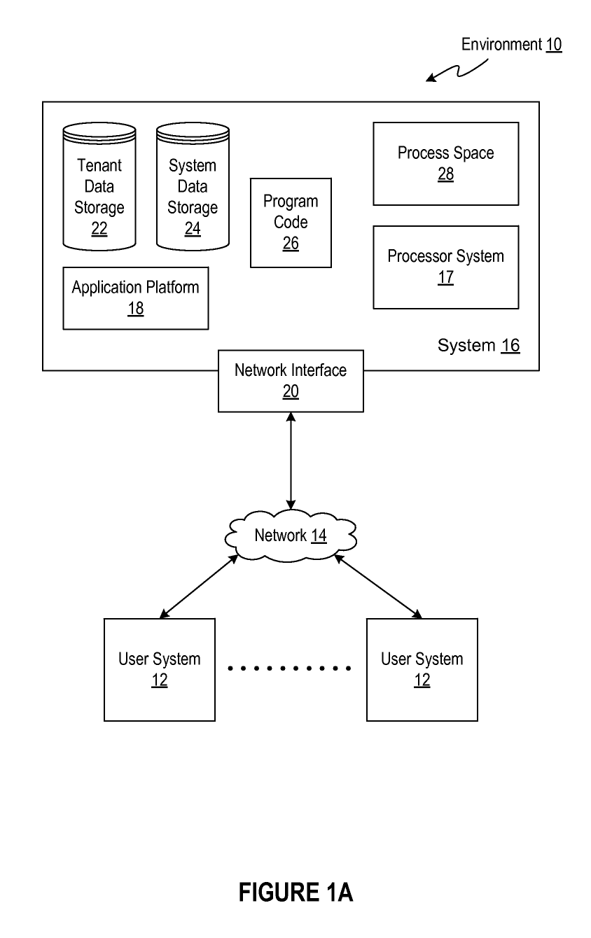

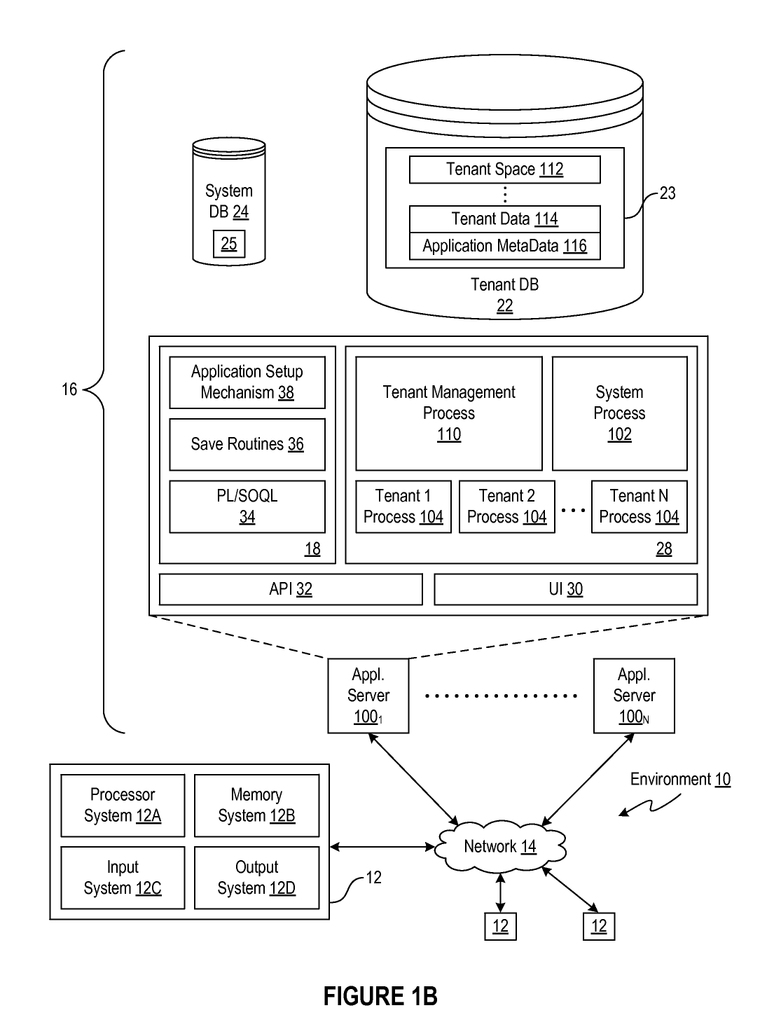

FIG. 1A shows a block diagram of an example of an environment 10 in which an on-demand database service can be used in accordance with some implementations. The environment 10 includes user systems 12, a network 14, a database system 16 (also referred to herein as a “cloud-based system”), a processor system 17, an application platform 18, a network interface 20, tenant database 22 for storing tenant data 23, system database 24 for storing system data 25, program code 26 for implementing various functions of the system 16, and process space 28 for executing database system processes and tenant-specific processes, such as running applications as part of an application hosting service. In some other implementations, environment 10 may not have all of these components or systems, or may have other components or systems instead of, or in addition to, those listed above.

In some implementations, the environment 10 is an environment in which an on-demand database service exists. An on-demand database service, such as that which can be implemented using the system 16, is a service that is made available to users outside of the enterprise(s) that own, maintain or provide access to the system 16. As described above, such users generally do not need to be concerned with building or maintaining the system 16. Instead, resources provided by the system 16 may be available for such users' use when the users need services provided by the system 16; that is, on the demand of the users. Some on-demand database services can store information from one or more tenants into tables of a common database image to form a multi-tenant database system (MTS). The term “multi-tenant database system” can refer to those systems in which various elements of hardware and software of a database system may be shared by one or more customers or tenants. For example, a given application server may simultaneously process requests for a great number of customers, and a given database table may store rows of data such as feed items for a potentially much greater number of customers. A database image can include one or more database objects. A relational database management system (RDBMS) or the equivalent can execute storage and retrieval of information against the database object(s).

Application platform 18 can be a framework that allows the applications of system 16 to execute, such as the hardware or software infrastructure of the system 16. In some implementations, the application platform 18 enables the creation, management and execution of one or more applications developed by the provider of the on-demand database service, users accessing the on-demand database service via user systems 12, or third party application developers accessing the on-demand database service via user systems 12.

In some implementations, the system 16 implements a web-based customer relationship management (CRM) system. For example, in some such implementations, the system 16 includes application servers configured to implement and execute CRM software applications as well as provide related data, code, forms, renderable web pages and documents and other information to and from user systems 12 and to store to, and retrieve from, a database system related data, objects, and Web page content. In some MTS implementations, data for multiple tenants may be stored in the same physical database object in tenant database 22. In some such implementations, tenant data is arranged in the storage medium(s) of tenant database 22 so that data of one tenant is kept logically separate from that of other tenants so that one tenant does not have access to another tenant's data, unless such data is expressly shared. The system 16 also implements applications other than, or in addition to, a CRM application. For example, the system 16 can provide tenant access to multiple hosted (standard and custom) applications, including a CRM application. User (or third party developer) applications, which may or may not include CRM, may be supported by the application platform 18. The application platform 18 manages the creation and storage of the applications into one or more database objects and the execution of the applications in one or more virtual machines in the process space of the system 16.

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (for example, in a server farm located in a single building or campus), or they may be distributed at locations remote from one another (for example, one or more servers located in city A and one or more servers located in city B). As used herein, each MTS could include one or more logically or physically connected servers distributed locally or across one or more geographic locations. Additionally, the term “server” is meant to refer to a computing device or system, including processing hardware and process space(s), an associated storage medium such as a memory device or database, and, in some instances, a database application (for example, OODBMS or RDBMS) as is well known in the art. It should also be understood that “server system” and “server” are often used interchangeably herein. Similarly, the database objects described herein can be implemented as part of a single database, a distributed database, a collection of distributed databases, a database with redundant online or offline backups or other redundancies, etc., and can include a distributed database or storage network and associated processing intelligence.

The network 14 can be or include any network or combination of networks of systems or devices that communicate with one another. For example, the network 14 can be or include any one or any combination of a LAN (local area network), WAN (wide area network), telephone network, wireless network, cellular network, point-to-point network, star network, token ring network, hub network, or other appropriate configuration. The network 14 can include a TCP/IP (Transfer Control Protocol and Internet Protocol) network, such as the global internetwork of networks often referred to as the “Internet” (with a capital “I”). The Internet will be used in many of the examples herein. However, it should be understood that the networks that the disclosed implementations can use are not so limited, although TCP/IP is a frequently implemented protocol.

The user systems 12 can communicate with system 16 using TCP/IP and, at a higher network level, other common Internet protocols to communicate, such as HTTP, FTP, AFS, WAP, etc. In an example where HTTP is used, each user system 12 can include an HTTP client commonly referred to as a “web browser” or simply a “browser” for sending and receiving HTTP signals to and from an HTTP server of the system 16. Such an HTTP server can be implemented as the sole network interface 20 between the system 16 and the network 14, but other techniques can be used in addition to or instead of these techniques. In some implementations, the network interface 20 between the system 16 and the network 14 includes load sharing functionality, such as round-robin HTTP request distributors to balance loads and distribute incoming HTTP requests evenly over a number of servers. In MTS implementations, each of the servers can have access to the MTS data; however, other alternative configurations may be used instead.

The user systems 12 can be implemented as any computing device(s) or other data processing apparatus or systems usable by users to access the database system 16. For example, any of user systems 12 can be a desktop computer, a work station, a laptop computer, a tablet computer, a handheld computing device, a mobile cellular phone (for example, a “smartphone”), or any other Wi-Fi-enabled device, wireless access protocol (WAP)-enabled device, or other computing device capable of interfacing directly or indirectly to the Internet or other network. The terms “user system” and “computing device” are used interchangeably herein with one another and with the term “computer.” As described above, each user system 12 typically executes an HTTP client, for example, a web browsing (or simply “browsing”) program, such as a web browser based on the WebKit platform, Microsoft's Internet Explorer browser, Netscape's Navigator browser, Opera's browser, Mozilla's Firefox browser, or a WAP-enabled browser in the case of a cellular phone, PDA or other wireless device, or the like, allowing a user (for example, a subscriber of on-demand services provided by the system 16) of the user system 12 to access, process and view information, pages and applications available to it from the system 16 over the network 14.

Each user system 12 also typically includes one or more user input devices, such as a keyboard, a mouse, a trackball, a touch pad, a touch screen, a pen or stylus or the like, for interacting with a graphical user interface (GUI) provided by the browser on a display (for example, a monitor screen, liquid crystal display (LCD), light-emitting diode (LED) display, among other possibilities) of the user system 12 in conjunction with pages, forms, applications and other information provided by the system 16 or other systems or servers. For example, the user interface device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

The users of user systems 12 may differ in their respective capacities, and the capacity of a particular user system 12 can be entirely determined by permissions (permission levels) for the current user of such user system. For example, where a salesperson is using a particular user system 12 to interact with the system 16, that user system can have the capacities allotted to the salesperson. However, while an administrator is using that user system 12 to interact with the system 16, that user system can have the capacities allotted to that administrator. Where a hierarchical role model is used, users at one permission level can have access to applications, data, and database information accessible by a lower permission level user, but may not have access to certain applications, database information, and data accessible by a user at a higher permission level. Thus, different users generally will have different capabilities with regard to accessing and modifying application and database information, depending on the users' respective security or permission levels (also referred to as “authorizations”).

According to some implementations, each user system 12 and some or all of its components are operator-configurable using applications, such as a browser, including computer code executed using a central processing unit (CPU) such as an Intel Pentium® processor or the like. Similarly, the system 16 (and additional instances of an MTS, where more than one is present) and all of its components can be operator-configurable using application(s) including computer code to run using the processor system 17, which may be implemented to include a CPU, which may include an Intel Pentium® processor or the like, or multiple CPUs.

The system 16 includes tangible computer-readable media having non-transitory instructions stored thereon/in that are executable by or used to program a server or other computing system (or collection of such servers or computing systems) to perform some of the implementation of processes described herein. For example, computer program code 26 can implement instructions for operating and configuring the system 16 to intercommunicate and to process web pages, applications and other data and media content as described herein. In some implementations, the computer code 26 can be downloadable and stored on a hard disk, but the entire program code, or portions thereof, also can be stored in any other volatile or non-volatile memory medium or device as is well known, such as a ROM or RAM, or provided on any media capable of storing program code, such as any type of rotating media including floppy disks, optical discs, digital versatile disks (DVD), compact disks (CD), microdrives, and magneto-optical disks, and magnetic or optical cards, nanosystems (including molecular memory ICs), or any other type of computer-readable medium or device suitable for storing instructions or data. Additionally, the entire program code, or portions thereof, may be transmitted and downloaded from a software source over a transmission medium, for example, over the Internet, or from another server, as is well known, or transmitted over any other existing network connection as is well known (for example, extranet, VPN, LAN, etc.) using any communication medium and protocols (for example, TCP/IP, HTTP, HTTPS, Ethernet, etc.) as are well known. It will also be appreciated that computer code for the disclosed implementations can be realized in any programming language that can be executed on a server or other computing system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

FIG. 1B shows a block diagram of example implementations of elements of FIG. 1A and example interconnections between these elements according to some implementations. That is, FIG. 1B also illustrates environment 10, but FIG. 1B, various elements of the system 16 and various interconnections between such elements are shown with more specificity according to some more specific implementations. Additionally, in FIG. 1B, the user system 12 includes a processor system 12A, a memory system 12B, an input system 12C, and an output system 12D. The processor system 12A can include any suitable combination of one or more processors. The memory system 12B can include any suitable combination of one or more memory devices. The input system 12C can include any suitable combination of input devices, such as one or more touchscreen interfaces, keyboards, mice, trackballs, scanners, cameras, or interfaces to networks. The output system 12D can include any suitable combination of output devices, such as one or more display devices, printers, or interfaces to networks.

In FIG. 1B, the network interface 20 is implemented as a set of HTTP application servers 100₁-100_{N}. Each application server 100, also referred to herein as an “app server”, is configured to communicate with tenant database 22 and the tenant data 23 therein, as well as system database 24 and the system data 25 therein, to serve requests received from the user systems 12. The tenant data 23 can be divided into individual tenant storage spaces 112, which can be physically or logically arranged or divided. Within each tenant storage space 112, user storage 114 and application metadata 116 can similarly be allocated for each user. For example, a copy of a user's most recently used (MRU) items can be stored to user storage 114. Similarly, a copy of MRU items for an entire organization that is a tenant can be stored to tenant storage space 112.

The process space 28 includes system process space 102, individual tenant process spaces 104 and a tenant management process space 110. The application platform 18 includes an application setup mechanism 38 that supports application developers' creation and management of applications. Such applications and others can be saved as metadata into tenant database 22 by save routines 36 for execution by subscribers as one or more tenant process spaces 104 managed by tenant management process 110, for example. Invocations to such applications can be coded using PL/SOQL 34, which provides a programming language style interface extension to API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications can be detected by one or more system processes, which manage retrieving application metadata 116 for the subscriber making the invocation and executing the metadata as an application in a virtual machine.

The system 16 of FIG. 1B also includes a user interface (UI) 30 and an application programming interface (API) 32 to system 16 resident processes to users or developers at user systems 12. In some other implementations, the environment 10 may not have the same elements as those listed above or may have other elements instead of, or in addition to, those listed above.

Each application server 100 can be communicably coupled with tenant database 22 and system database 24, for example, having access to tenant data 23 and system data 25, respectively, via a different network connection. For example, one application server 100₁ can be coupled via the network 14 (for example, the Internet), another application server 100_{N-1} can be coupled via a direct network link, and another application server 100_{N} can be coupled by yet a different network connection. Transfer Control Protocol and Internet Protocol (TCP/IP) are examples of typical protocols that can be used for communicating between application servers 100 and the system 16. However, it will be apparent to one skilled in the art that other transport protocols can be used to optimize the system 16 depending on the network interconnections used.

In some implementations, each application server 100 is configured to handle requests for any user associated with any organization that is a tenant of the system 16. Because it can be desirable to be able to add and remove application servers 100 from the server pool at any time and for various reasons, in some implementations there is no server affinity for a user or organization to a specific application server 100. In some such implementations, an interface system implementing a load balancing function (for example, an F5 Big-IP load balancer) is communicably coupled between the application servers 100 and the user systems 12 to distribute requests to the application servers 100. In one implementation, the load balancer uses a least-connections algorithm to route user requests to the application servers 100. Other examples of load balancing algorithms, such as round robin and observed-response-time, also can be used. For example, in some instances, three consecutive requests from the same user could hit three different application servers 100, and three requests from different users could hit the same application server 100. In this manner, by way of example, system 16 can be a multi-tenant system in which system 16 handles storage of, and access to, different objects, data and applications across disparate users and organizations.

In one example storage use case, one tenant can be a company that employs a sales force where each salesperson uses system 16 to manage aspects of their sales. A user can maintain contact data, leads data, customer follow-up data, performance data, goals and progress data, etc., all applicable to that user's personal sales process (for example, in tenant database 22). In an example of a MTS arrangement, because all of the data and the applications to access, view, modify, report, transmit, calculate, etc., can be maintained and accessed by a user system 12 having little more than network access, the user can manage his or her sales efforts and cycles from any of many different user systems. For example, when a salesperson is visiting a customer and the customer has Internet access in their lobby, the salesperson can obtain critical updates regarding that customer while waiting for the customer to arrive in the lobby.

While each user's data can be stored separately from other users' data regardless of the employers of each user, some data can be organization-wide data shared or accessible by several users or all of the users for a given organization that is a tenant. Thus, there can be some data structures managed by system 16 that are allocated at the tenant level while other data structures can be managed at the user level. Because an MTS can support multiple tenants including possible competitors, the MTS can have security protocols that keep data, applications, and application use separate. Also, because many tenants may opt for access to an MTS rather than maintain their own system, redundancy, up-time, and backup are additional functions that can be implemented in the MTS. In addition to user-specific data and tenant-specific data, the system 16 also can maintain system level data usable by multiple tenants or other data. Such system level data can include industry reports, news, postings, and the like that are sharable among tenants.

In some implementations, the user systems 12 (which also can be client systems) communicate with the application servers 100 to request and update system-level and tenant-level data from the system 16. Such requests and updates can involve sending one or more queries to tenant database 22 or system database 24. The system 16 (for example, an application server 100 in the system 16) can automatically generate one or more SQL statements (for example, one or more SQL queries) designed to access the desired information. System database 24 can generate query plans to access the requested data from the database. The term “query plan” generally refers to one or more operations used to access information in a database system.

Each database can generally be viewed as a collection of objects, such as a set of logical tables, containing data fitted into predefined or customizable categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or element of a table can contain an instance of data for each category defined by the fields. For example, a CRM database can include a table that describes a customer with fields for basic contact information such as name, address, phone number, fax number, etc. Another table can describe a purchase order, including fields for information such as customer, product, sale price, date, etc. In some MTS implementations, standard entity tables can be provided for use by all tenants. For CRM database applications, such standard entities can include tables for case, account, contact, lead, and opportunity data objects, each containing pre-defined fields. As used herein, the term “entity” also may be used interchangeably with “object” and “table.”

In some MTS implementations, tenants are allowed to create and store custom objects, or may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In some implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

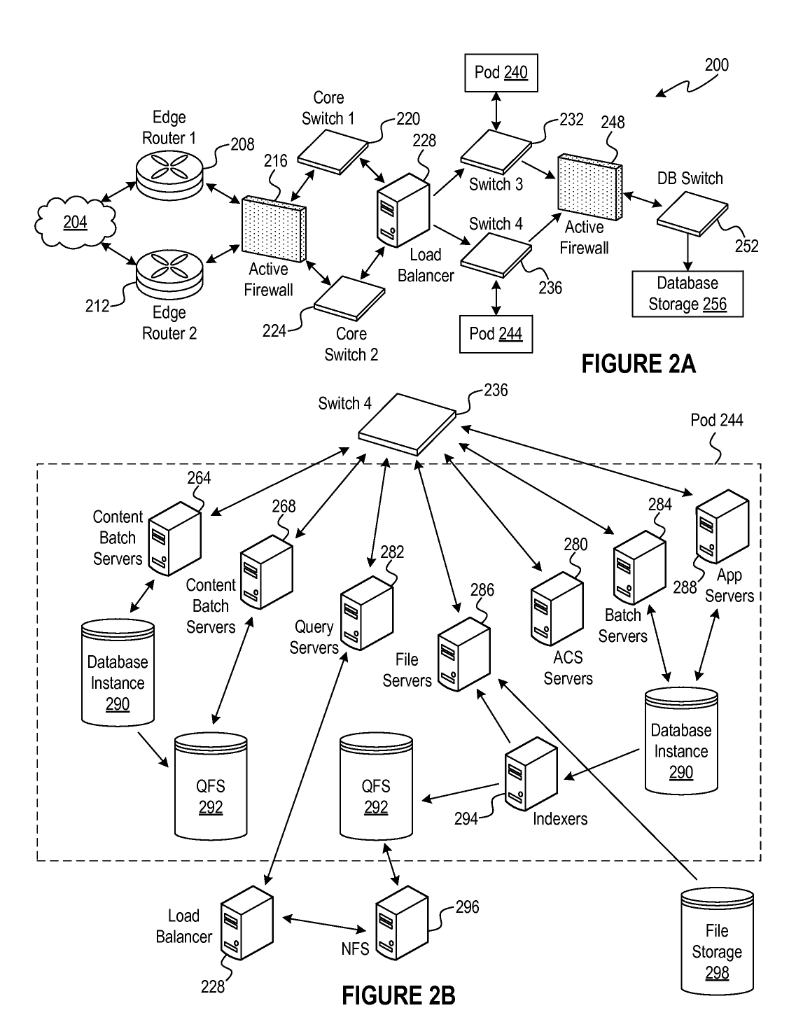

FIG. 2A shows a system diagram illustrating example architectural components of an on-demand database service environment 200 according to some implementations. A client machine communicably connected with the cloud 204, generally referring to one or more networks in combination, as described herein, can communicate with the on-demand database service environment 200 via one or more edge routers 208 and 212. A client machine can be any of the examples of user systems 12 described above. The edge routers can communicate with one or more core switches 220 and 224 through a firewall 216. The core switches can communicate with a load balancer 228, which can distribute server load over different pods, such as the pods 240 and 244. The pods 240 and 244, which can each include one or more servers or other computing resources, can perform data processing and other operations used to provide on-demand services. Communication with the pods can be conducted via pod switches 232 and 236. Components of the on-demand database service environment can communicate with database storage 256 through a database firewall 248 and a database switch 252.

As shown in FIGS. 2A and 2B, accessing an on-demand database service environment can involve communications transmitted among a variety of different hardware or software components. Further, the on-demand database service environment 200 is a simplified representation of an actual on-demand database service environment. For example, while only one or two devices of each type are shown in FIGS. 2A and 2B, some implementations of an on-demand database service environment can include anywhere from one to several devices of each type. Also, the on-demand database service environment need not include each device shown in FIGS. 2A and 2B, or can include additional devices not shown in FIGS. 2A and 2B.

Additionally, it should be appreciated that one or more of the devices in the on-demand database service environment 200 can be implemented on the same physical device or on different hardware. Some devices can be implemented using hardware or a combination of hardware and software. Thus, terms such as “data processing apparatus,” “machine,” “server” and “device” as used herein are not limited to a single hardware device, rather references to these terms can include any suitable combination of hardware and software configured to provide the described functionality.

The cloud 204 is intended to refer to a data network or multiple data networks, often including the Internet. Client machines communicably connected with the cloud 204 can communicate with other components of the on-demand database service environment 200 to access services provided by the on-demand database service environment. For example, client machines can access the on-demand database service environment to retrieve, store, edit, or process information. In some implementations, the edge routers 208 and 212 route packets between the cloud 204 and other components of the on-demand database service environment 200. For example, the edge routers 208 and 212 can employ the Border Gateway Protocol (BGP). The BGP is the core routing protocol of the Internet. The edge routers 208 and 212 can maintain a table of IP networks or ‘prefixes’, which designate network reachability among autonomous systems on the Internet.

In some implementations, the firewall 216 can protect the inner components of the on-demand database service environment 200 from Internet traffic. The firewall 216 can block, permit, or deny access to the inner components of the on-demand database service environment 200 based upon a set of rules and other criteria. The firewall 216 can act as one or more of a packet filter, an application gateway, a stateful filter, a proxy server, or any other type of firewall.

In some implementations, the core switches 220 and 224 are high-capacity switches that transfer packets within the on-demand database service environment 200. The core switches 220 and 224 can be configured as network bridges that quickly route data between different components within the on-demand database service environment. In some implementations, the use of two or more core switches 220 and 224 can provide redundancy or reduced latency.

In some implementations, the pods 240 and 244 perform the core data processing and service functions provided by the on-demand database service environment. Each pod can include various types of hardware or software computing resources. An example of the pod architecture is discussed in greater detail with reference to FIG. 2B. In some implementations, communication between the pods 240 and 244 is conducted via the pod switches 232 and 236. The pod switches 232 and 236 can facilitate communication between the pods 240 and 244 and client machines communicably connected with the cloud 204, for example via core switches 220 and 224. Also, the pod switches 232 and 236 may facilitate communication between the pods 240 and 244 and the database storage 256. In some implementations, the load balancer 228 can distribute workload between the pods 240 and 244. Balancing the on-demand service requests between the pods can assist in improving the use of resources, increasing throughput, reducing response times, or reducing overhead. The load balancer 228 may include multilayer switches to analyze and forward traffic.

In some implementations, access to the database storage 256 is guarded by a database firewall 248. The database firewall 248 can act as a computer application firewall operating at the database application layer of a protocol stack. The database firewall 248 can protect the database storage 256 from application attacks such as structure query language (SQL) injection, database rootkits, and unauthorized information disclosure. In some implementations, the database firewall 248 includes a host using one or more forms of reverse proxy services to proxy traffic before passing it to a gateway router. The database firewall 248 can inspect the contents of database traffic and block certain content or database requests. The database firewall 248 can work on the SQL application level atop the TCP/IP stack, managing applications' connection to the database or SQL management interfaces as well as intercepting and enforcing packets traveling to or from a database network or application interface.

In some implementations, communication with the database storage 256 is conducted via the database switch 252. The multi-tenant database storage 256 can include more than one hardware or software components for handling database queries. Accordingly, the database switch 252 can direct database queries transmitted by other components of the on-demand database service environment (for example, the pods 240 and 244) to the correct components within the database storage 256. In some implementations, the database storage 256 is an on-demand database system shared by many different organizations as described above with reference to FIGS. 1A and 1B.

FIG. 2B shows a system diagram further illustrating example architectural components of an on-demand database service environment according to some implementations. The pod 244 can be used to render services to a user of the on-demand database service environment 200. In some implementations, each pod includes a variety of servers or other systems. The pod 244 includes one or more content batch servers 264, content search servers 268, query servers 282, file force servers 286, access control system (ACS) servers 280, batch servers 284, and app servers 288. The pod 244 also can include database instances 290, quick file systems (QFS) 292, and indexers 294. In some implementations, some or all communication between the servers in the pod 244 can be transmitted via the switch 236.

In some implementations, the app servers 288 include a hardware or software framework dedicated to the execution of procedures (for example, programs, routines, scripts) for supporting the construction of applications provided by the on-demand database service environment 200 via the pod 244. In some implementations, the hardware or software framework of an app server 288 is configured to execute operations of the services described herein, including performance of the blocks of various methods or processes described herein. In some alternative implementations, two or more app servers 288 can be included and cooperate to perform such methods, or one or more other servers described herein can be configured to perform the disclosed methods.

The content batch servers 264 can handle requests internal to the pod. Some such requests can be long-running or not tied to a particular customer. For example, the content batch servers 264 can handle requests related to log mining, cleanup work, and maintenance tasks. The content search servers 268 can provide query and indexer functions. For example, the functions provided by the content search servers 268 can allow users to search through content stored in the on-demand database service environment. The file force servers 286 can manage requests for information stored in the Fileforce storage 298. The Fileforce storage 298 can store information such as documents, images, and basic large objects (BLOBs). By managing requests for information using the file force servers 286, the image footprint on the database can be reduced. The query servers 282 can be used to retrieve information from one or more file systems. For example, the query system 282 can receive requests for information from the app servers 288 and transmit information queries to the NFS 296 located outside the pod.

The pod 244 can share a database instance 290 configured as a multi-tenant environment in which different organizations share access to the same database. Additionally, services rendered by the pod 244 may call upon various hardware or software resources. In some implementations, the ACS servers 280 control access to data, hardware resources, or software resources. In some implementations, the batch servers 284 process batch jobs, which are used to run tasks at specified times. For example, the batch servers 284 can transmit instructions to other servers, such as the app servers 288, to trigger the batch jobs.

In some implementations, the QFS 292 is an open source file system available from Sun Microsystems® of Santa Clara, Calif. The QFS can serve as a rapid-access file system for storing and accessing information available within the pod 244. The QFS 292 can support some volume management capabilities, allowing many disks to be grouped together into a file system. File system metadata can be kept on a separate set of disks, which can be useful for streaming applications where long disk seeks cannot be tolerated. Thus, the QFS system can communicate with one or more content search servers 268 or indexers 294 to identify, retrieve, move, or update data stored in the network file systems 296 or other storage systems.

In some implementations, one or more query servers 282 communicate with the NFS 296 to retrieve or update information stored outside of the pod 244. The NFS 296 can allow servers located in the pod 244 to access information to access files over a network in a manner similar to how local storage is accessed. In some implementations, queries from the query servers 282 are transmitted to the NFS 296 via the load balancer 228, which can distribute resource requests over various resources available in the on-demand database service environment. The NFS 296 also can communicate with the QFS 292 to update the information stored on the NFS 296 or to provide information to the QFS 292 for use by servers located within the pod 244.

In some implementations, the pod includes one or more database instances 290. The database instance 290 can transmit information to the QFS 292. When information is transmitted to the QFS, it can be available for use by servers within the pod 244 without using an additional database call. In some implementations, database information is transmitted to the indexer 294. Indexer 294 can provide an index of information available in the database 290 or QFS 292. The index information can be provided to file force servers 286 or the QFS 292.

### II. Enterprise Social Networking

As initially described above, in some implementations, some of the methods, processes, devices and systems described herein can implement, or be used in the context of, enterprise social networking. Some online enterprise social networks can be implemented in various settings, including businesses, organizations and other enterprises (all of which are used interchangeably herein). For instance, an online enterprise social network can be implemented to connect users within a business corporation, partnership or organization, or a group of users within such an enterprise. For instance, Chatter® can be used by users who are employees in a business organization to share data, communicate, and collaborate with each other for various enterprise-related purposes. Some of the disclosed methods, processes, devices, systems and computer-readable storage media described herein can be configured or designed for use in a multi-tenant database environment, such as described above with respect to system 16. In an example implementation, each organization or a group within the organization can be a respective tenant of the system.

In some implementations, each user of the database system 16 is associated with a “user profile.” A user profile refers generally to a collection of data about a given user. The data can include general information, such as a name, a title, a phone number, a photo, a biographical summary, or a status (for example, text describing what the user is currently doing, thinking or expressing). As described below, the data can include messages created by other users. In implementations in which there are multiple tenants, a user is typically associated with a particular tenant (or “organization”). For example, a user could be a salesperson of an organization that is a tenant of the database system 16.

A “group” generally refers to a collection of users within an organization. In some implementations, a group can be defined as users with the same or a similar attribute, or by membership or subscription. Groups can have various visibilities to users within an enterprise social network. For example, some groups can be private while others can be public. In some implementations, to become a member within a private group, and to have the capability to publish and view feed items on the group's group feed, a user must request to be subscribed to the group (and be accepted by, for example, an administrator or owner of the group), be invited to subscribe to the group (and accept), or be directly subscribed to the group (for example, by an administrator or owner of the group). In some implementations, any user within the enterprise social network can subscribe to or follow a public group (and thus become a “member” of the public group) within the enterprise social network.

A “record” generally refers to a data entity, such as an instance of a data object created by a user or group of users of the database system 16. Such records can include, for example, data objects representing and maintaining data for accounts, cases, opportunities, leads, files, documents, orders, pricebooks, products, solutions, reports and forecasts, among other possibilities. For example, a record can be for a business partner or potential business partner (for example, a client, vendor, distributor, etc.) of a user or a user's organization, and can include information describing an entire enterprise, subsidiaries of an enterprise, or contacts at the enterprise. As another example, a record can be a project that a user or group of users is/are working on, such as an opportunity (for example, a possible sale) with an existing partner, or a project that the user is trying to obtain. A record has data fields that are defined by the structure of the object (for example, fields of certain data types and purposes). A record also can have custom fields defined by a user or organization. A field can include (or include a link to) another record, thereby providing a parent-child relationship between the records.

Records also can have various visibilities to users within an enterprise social network. For example, some records can be private while others can be public. In some implementations, to access a private record, and to have the capability to publish and view feed items on the record's record feed, a user must request to be subscribed to the record (and be accepted by, for example, an administrator or owner of the record), be invited to subscribe to the record (and accept), be directly subscribed to the record or be shared the record (for example, by an administrator or owner of the record). In some implementations, any user within the enterprise social network can subscribe to or follow a public record within the enterprise social network.

In some online enterprise social networks, users also can follow one another by establishing “links” or “connections” with each other, sometimes referred to as “friending” one another. By establishing such a link, one user can see information generated by, generated about, or otherwise associated with another user. For instance, a first user can see information posted by a second user to the second user's profile page. In one example, when the first user is following the second user, the first user's news feed can receive a post from the second user submitted to the second user's profile feed.

In some implementations, users can access one or more enterprise network feeds (also referred to herein simply as “feeds”), which include publications presented as feed items or entries in the feed. A network feed can be displayed in a graphical user interface (GUI) on a display device such as the display of a user's computing device as described above. The publications can include various enterprise social network information or data from various sources and can be stored in the database system 16, for example, in tenant database 22. In some implementations, feed items of information for or about a user can be presented in a respective user feed, feed items of information for or about a group can be presented in a respective group feed, and feed items of information for or about a record can be presented in a respective record feed. A second user following a first user, a first group, or a first record can automatically receive the feed items associated with the first user, the first group or the first record for display in the second user's news feed. In some implementations, a user feed also can display feed items from the group feeds of the groups the respective user subscribes to, as well as feed items from the record feeds of the records the respective user subscribes to.

The term “feed item” (or feed element) refers to an item of information, which can be viewable in a feed. Feed items can include publications such as messages (for example, user-generated textual posts or comments), files (for example, documents, audio data, image data, video data or other data), and “feed-tracked” updates associated with a user, a group or a record (feed-tracked updates are described in greater detail below). A feed item, and a feed in general, can include combinations of messages, files and feed-tracked updates. Documents and other files can be included in, linked with, or attached to a post or comment. For example, a post can include textual statements in combination with a document. The feed items can be organized in chronological order or another suitable or desirable order (which can be customizable by a user) when the associated feed is displayed in a graphical user interface (GUI), for instance, on the user's computing device.

Messages such as posts can include alpha-numeric or other character-based user inputs such as words, phrases, statements, questions, emotional expressions, or symbols. In some implementations, a comment can be made on any feed item. In some implementations, comments are organized as a list explicitly tied to a particular feed item such as a feed-tracked update, post, or status update. In some implementations, comments may not be listed in the first layer (in a hierarchal sense) of feed items, but listed as a second layer branching from a particular first layer feed item. In some implementations, a “like” or “dislike” also can be submitted in response to a particular post, comment or other publication.

A “feed-tracked update,” also referred to herein as a “feed update,” is another type of publication that may be presented as a feed item and generally refers to data representing an event. A feed-tracked update can include text generated by the database system in response to the event, to be provided as one or more feed items for possible inclusion in one or more feeds. In one implementation, the data can initially be stored by the database system in, for example, tenant database 22, and subsequently used by the database system to create text for describing the event. Both the data and the text can be a feed-tracked update, as used herein. In some implementations, an event can be an update of a record and can be triggered by a specific action by a user. Which actions trigger an event can be configurable. Which events have feed-tracked updates created and which feed updates are sent to which users also can be configurable. Messages and feed updates can be stored as a field or child object of a record. For example, the feed can be stored as a child object of the record.

As described above, a network feed can be specific to an individual user of an online social network. For instance, a user news feed (or “user feed”) generally refers to an aggregation of feed items generated for a particular user, and in some implementations, is viewable only to the respective user on a home page of the user. In some implementations a user profile feed (also referred to as a “user feed”) is another type of user feed that refers to an aggregation of feed items generated by or for a particular user, and in some implementations, is viewable only by the respective user and other users following the user on a profile page of the user. As a more specific example, the feed items in a user profile feed can include posts and comments that other users make about or send to the particular user, and status updates made by the particular user. As another example, the feed items in a user profile feed can include posts made by the particular user and feed-tracked updates initiated based on actions of the particular user.

As is also described above, a network feed can be specific to a group of enterprise users of an online enterprise social network. For instance, a group news feed (or “group feed”) generally refers to an aggregation of feed items generated for or about a particular group of users of the database system 16 and can be viewable by users following or subscribed to the group on a profile page of the group. For example, such feed items can include posts made by members of the group or feed-tracked updates about changes to the respective group (or changes to documents or other files shared with the group). Members of the group can view and post to a group feed in accordance with a permissions configuration for the feed and the group. Publications in a group context can include documents, posts, or comments. In some implementations, the group feed also includes publications and other feed items that are about the group as a whole, the group's purpose, the group's description, a status of the group, and group records and other objects stored in association with the group. Threads of publications including updates and messages, such as posts, comments, likes, etc., can define conversations and change over time. The following of a group allows a user to collaborate with other users in the group, for example, on a record or on documents or other files (which may be associated with a record).

As is also described above, a network feed can be specific to a record in an online enterprise social network. For instance, a record news feed (or “record feed”) generally refers to an aggregation of feed items about a particular record in the database system 16 and can be viewable by users subscribed to the record on a profile page of the record. For example, such feed items can include posts made by users about the record or feed-tracked updates about changes to the respective record (or changes to documents or other files associated with the record). Subscribers to the record can view and post to a record feed in accordance with a permissions configuration for the feed and the record. Publications in a record context also can include documents, posts, or comments. In some implementations, the record feed also includes publications and other feed items that are about the record as a whole, the record's purpose, the record's description, and other records or other objects stored in association with the record. Threads of publications including updates and messages, such as posts, comments, likes, etc., can define conversations and change over time. The following of a record allows a user to track the progress of that record and collaborate with other users subscribing to the record, for example, on the record or on documents or other files associated with the record.

In some implementations, data is stored in database system 16, including tenant database 22, in the form of “entity objects” (also referred to herein simply as “entities”). In some implementations, entities are categorized into “Records objects” and “Collaboration objects.” In some such implementations, the Records object includes all records in the enterprise social network. Each record can be considered a sub-object of the overarching Records object. In some implementations, Collaboration objects include, for example, a “Users object,” a “Groups object,” a “Group-User relationship object,” a “Record-User relationship object” and a “Feed Items object.”

In some implementations, the Users object is a data structure that can be represented or conceptualized as a “Users Table” that associates users to information about or pertaining to the respective users including, for example, metadata about the users. In some implementations, the Users Table includes all of the users within an organization. In some other implementations, there can be a Users Table for each division, department, team or other sub-organization within an organization. In implementations in which the organization is a tenant of a multi-tenant enterprise social network platform, the Users Table can include all of the users within all of the organizations that are tenants of the multi-tenant enterprise social network platform. In some implementations, each user can be identified by a user identifier (“UserID”) that is unique at least within the user's respective organization. In some such implementations, each organization also has a unique organization identifier (“OrgID”).

In some implementations, the Groups object is a data structure that can be represented or conceptualized as a “Groups Table” that associates groups to information about or pertaining to the respective groups including, for example, metadata about the groups. In some implementations, the Groups Table includes all of the groups within the organization. In some other implementations, there can be a Groups Table for each division, department, team or other sub-organization within an organization. In implementations in which the organization is a tenant of a multi-tenant enterprise social network platform, the Groups Table can include all of the groups within all of the organizations that are tenants of the multitenant enterprise social network platform. In some implementations, each group can be identified by a group identifier (“GrouplD”) that is unique at least within the respective organization.

In some implementations, the database system 16 includes a “Group-User relationship object.” The Group-User relationship object is a data structure that can be represented or conceptualized as a “Group-User Table” that associates groups to users subscribed to the respective groups. In some implementations, the Group-User Table includes all of the groups within the organization. In some other implementations, there can be a Group-User Table for each division, department, team or other sub-organization within an organization. In implementations in which the organization is a tenant of a multi-tenant enterprise social network platform, the Group-User Table can include all of the groups within all of the organizations that are tenants of the multitenant enterprise social network platform.

In some implementations, the Records object is a data structure that can be represented or conceptualized as a “Records Table” that associates records to information about or pertaining to the respective records including, for example, metadata about the records. In some implementations, the Records Table includes all of the records within the organization. In some other implementations, there can be a Records Table for each division, department, team or other sub-organization within an organization. In implementations in which the organization is a tenant of a multi-tenant enterprise social network platform, the Records Table can include all of the records within all of the organizations that are tenants of the multitenant enterprise social network platform. In some implementations, each record can be identified by a record identifier (“RecordID”) that is unique at least within the respective organization.

In some implementations, the database system 16 includes a “Record-User relationship object.” The Record-User relationship object is a data structure that can be represented or conceptualized as a “Record-User Table” that associates records to users subscribed to the respective records. In some implementations, the Record-User Table includes all of the records within the organization. In some other implementations, there can be a Record-User Table for each division, department, team or other sub-organization within an organization. In implementations in which the organization is a tenant of a multi-tenant enterprise social network platform, the Record-User Table can include all of the records within all of the organizations that are tenants of the multitenant enterprise social network platform.

In some implementations, the database system 16 includes a “Feed Items object.” The Feed items object is a data structure that can be represented or conceptualized as a “Feed Items Table” that associates users, records and groups to posts, comments, documents or other publications to be displayed as feed items in the respective user feeds, record feeds and group feeds, respectively. In some implementations, the Feed Items Table includes all of the feed items within the organization. In some other implementations, there can be a Feed Items Table for each division, department, team or other sub-organization within an organization. In implementations in which the organization is a tenant of a multi-tenant enterprise social network platform, the Feed Items Table can include all of the feed items within all of the organizations that are tenants of the multitenant enterprise social network platform.

Enterprise social network news feeds are different from typical consumer-facing social network news feeds (for example, FACEBOOK®) in many ways, including in the way they prioritize information. In consumer-facing social networks, the focus is generally on helping the social network users find information that they are personally interested in. But in enterprise social networks, it can, in some instances, applications, or implementations, be desirable from an enterprise's perspective to only distribute relevant enterprise-related information to users and to limit the distribution of irrelevant information. In some implementations, relevant enterprise-related information refers to information that would be predicted or expected to benefit the enterprise by virtue of the recipients knowing the information, such as an update to a database record maintained by or on behalf of the enterprise. Thus, the meaning of relevance differs significantly in the context of a consumer-facing social network as compared with an employee-facing or organization member-facing enterprise social network.

In some implementations, when data such as posts or comments from one or more enterprise users are submitted to a network feed for a particular user, group, record or other object within an online enterprise social network, an email notification or other type of network communication may be transmitted to all users following the respective user, group, record or object in addition to the inclusion of the data as a feed item in one or more user, group, record or other feeds. In some online enterprise social networks, the occurrence of such a notification is limited to the first instance of a published input, which may form part of a larger conversation. For instance, a notification may be transmitted for an initial post, but not for comments on the post. In some other implementations, a separate notification is transmitted for each such publication, such as a comment on a post.

### III. Biometric Monitoring

Certain implementations relate to an application that may be used by clinicians to access a patient's biometric data in real-time and perform predictive analysis on several high risk physiological parameters (such as blood glucose level, blood pressure, and heart rate). The application may also be utilized to define specific rules for one or more physiological parameters, which may in turn be used to generate notifications (“alerts”) for clinicians and/or the patient when the rule is triggered by the biometric data. For example, a rule may correspond to a threshold condition that is triggered when a particular parameter drops below or increases above a threshold value. The clinician has the ability to define the rules for generating alerts, thus granting the clinician the ability to tailor alerts to specific patients depending on the medical needs of the patient and his/her history. Alerts generated based on the rules may be summarized in a “case”, or physiological/medical record, built for the patient, and which may be subsequently transmitted to the patient.

The patient may be fitted with a wearable/mobile device capable of capturing biometric data (e.g., blood pressure, glucose levels, etc.) as the patient lives out his/her daily life. The captured data is transmitted to a host database system where it is stored and analyzed. The system may generate push notifications that are sent to a clinician of the patient when the biometric data satisfies one or more clinician-defined rules. These notifications alert the clinician of a potential patient condition without requiring the clinician to review all of the patient data. By performing real-time monitoring at a remote location, patients may be remotely alerted to potential health risks (e.g., at the clinician's discretion), which is advantageous as a fully automated system may needlessly frighten the patient having a lay-person's understanding of his/her health.

While the implementations for real-time biometric monitoring and alert generation have been described herein as being a tool for monitoring the health of patients, these implementations may be utilized in other applications as well. For example, professional athletes may use the implementations described herein to remotely monitor workout intensity in conjunction with a personal trainer. In addition, the implementations may be used by firemen, police officers, military personnel, or other individuals in high-risk environments to remotely monitor their vitals in the field.

As used herein, the term “biometric parameter” refers to any measureable physiological quantity associated with an individual, such as heart rate, body temperature, body composition (e.g., body mass index, percent body fat, etc.), hemoglobin levels, cholesterol, blood pressure, respiratory rate, blood glucose levels, triglycerides, or other parameters.

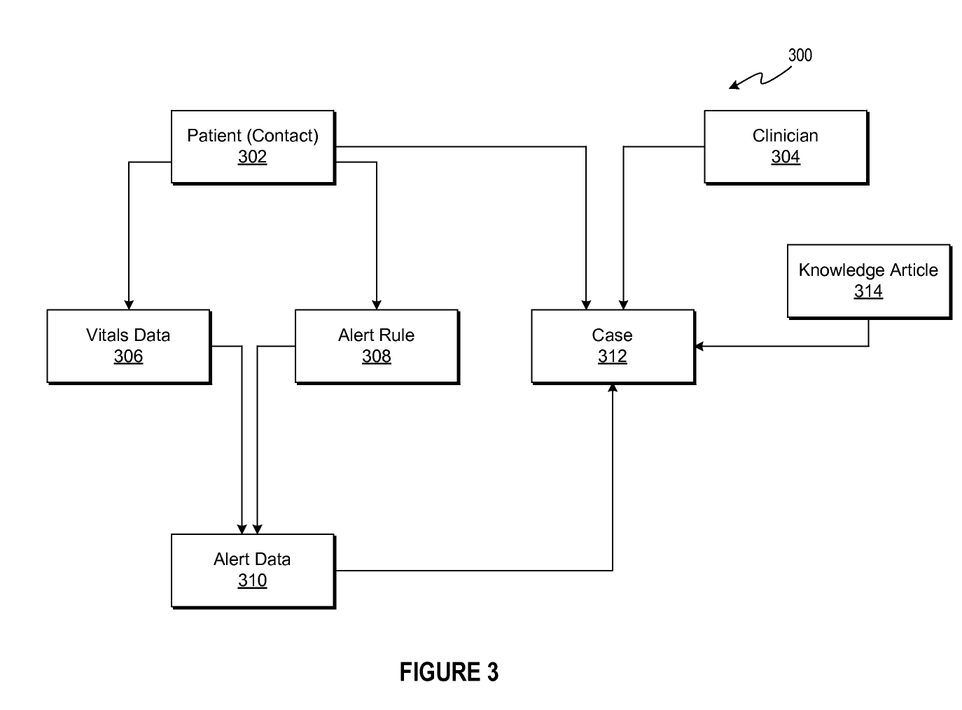

FIG. 3 illustrates an exemplary data model 300 of the application for real-time biometric monitoring according to some implementations. The data model 300 includes data objects including, but not limited to, a patient object 302, a user object 304, vitals data 306, an alert rule 308, an alert 310, a case 312, and a knowledge article 314. The lines/arrows interconnecting the various objects in the data model 300 represent data flow from one object to another. The data model may be implemented within the framework of a multi-tenant database system, as described herein.

In one implementation, the user object 304 represents a user of the application, such as a clinician. The user/clinician can create a case 312, which serves a physiological/medical record for a patient (represented by the patient object 302) that may summarize a health condition of the patient. For each patient, the clinician may define an alert rule 308 that is triggered when a condition relating to the patient's vitals data 306 is met. The vitals data 306 include all data collected for a particular patient, including data corresponding to various physiological parameters. Physiological parameters may be referred to collectively as “vitals”. The rule may be referred to as an “alert rule” or a “clinician-defined rule”.

In some implementations, when an alert rule 308 is satisfied by the vitals data 306, alert data 310 is generated, which includes a time it was generated, a portion of vitals 304 data from which the alert was created, as well as other information that may be useful to the clinician in preparing the case 312. For each set of alert data 310 generated, the clinician may select which data to add to the case 312. In some implementations, alert data 310 may be automatically added to a case 312. In some implementations, the knowledge article 314 corresponds to a repository of information, including articles on specific health issues, pre-defined messages (e.g., and subsequently transmit to a patient), or other information available to the clinician that may be useful for adding to the case 312. Once the case 312 is generated, the clinician may modify the case by adding new alert data and/or curating information within the case 312 as desired.

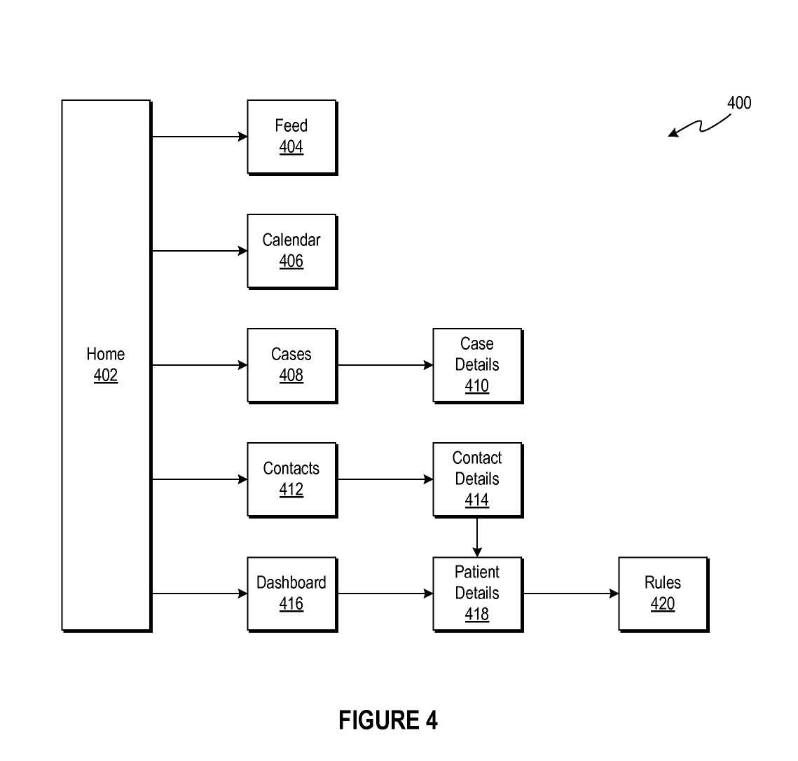

FIG. 4 illustrates an exemplary application sitemap 400 for real-time biometric monitoring according to some implementations. The sitemap 400 includes a home screen 402 that may allow a user/clinician to navigate through various aspects of the application, including a feed 404 (which may display updates pertaining to alerts, cases, vitals, etc.), a calendar 406 for keeping track of patient appointments, a list of cases 408 (from which case details 410 can be accessed), a list of contacts 412 (e.g., patients, other clinicians, etc.), and a dashboard 416. Contact details 414 may be accessed to provide details pertaining to each of the contacts, and may implemented using search filters. The dashboard 416 may combine various aspects of the sitemap 400 into a customizable interface, and may allow the clinician to explore patient details 418 and define alert rules 420.

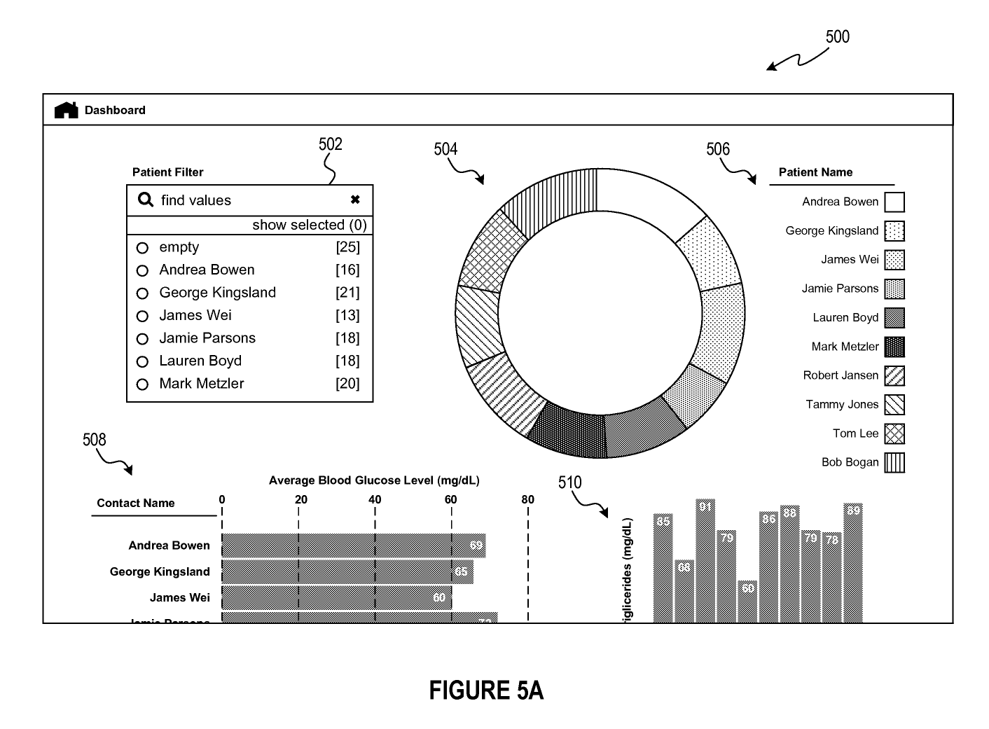

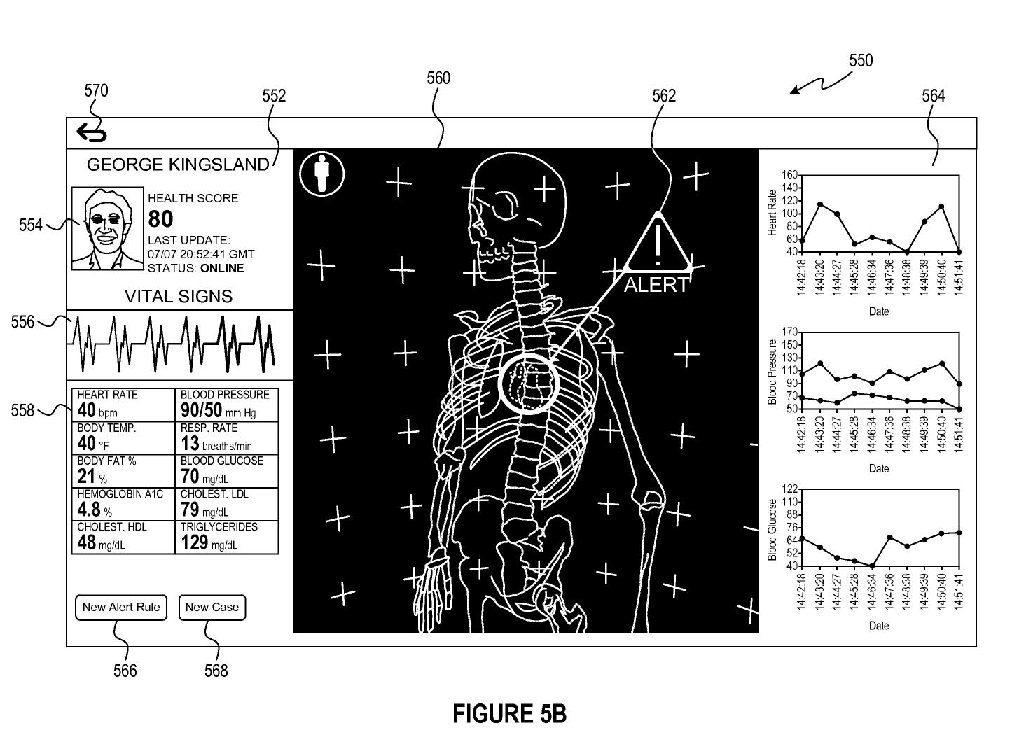

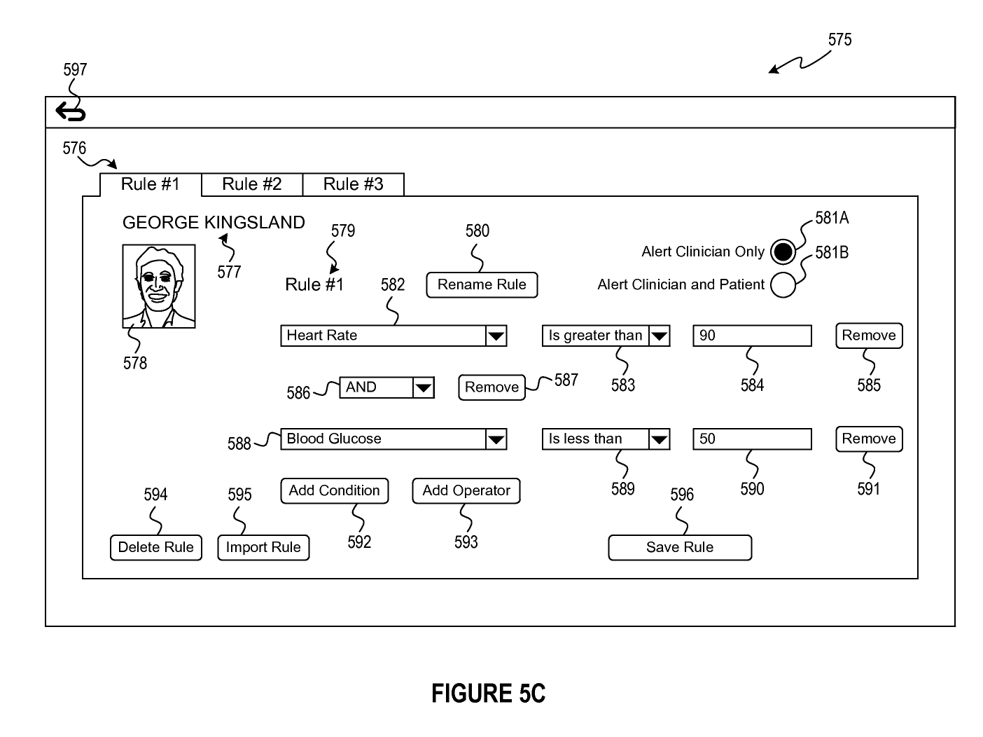

FIG. 5A shows an illustrative user interface 500 (“dashboard”) for accessing and reviewing patient data for a group of patients according to some implementations. For example, the user interface 500 may correspond to the dashboard 416 of the sitemap described with respect to FIG. 4. The user interface 500 may be implemented, for example, on a device operated by a user (or a group of user). The user (or users) utilizing the user interface 500 may be a clinician (or clinicians) responsible for one or more of the patients in the group.

The user interface 500 includes various on-screen components to facilitate real-time monitoring of patient information. For example, the user interface includes a search window 502 to search for information related to one or more patients (such as a search for a health-related parameter, a medical condition, a name, a residence location, an appointment date, etc.). In response to a search query, the search window 502 may return a list of contacts associated with terms/parameters that match the search results.

The user interface 500 further includes a health indicator 504 and a list of patients 506. The health indicator 504 may be used to provide a visual aid to the user in order to identify patients who may be in a diminished state of health. In some implementations, each portion of the health indicator 504 represents a particular patient, and the portions may be color-coded with the list of patients 506 serving as a key. Each patient may have an associated health score that is a function of various physiological parameters, and the portions of the health indicator 504 may have their appearances modulated based on the health scores. In some implementations, the health scores may be based on a function defined by the clinician.

In some implementations, a relative size of a portion may be a function of a health score of its associated patient. In some implementations, a color of a portion may be modulated as a function of a health score of its associated patient (e.g., green represents a maximum health score, red represents a health score below a designated safe threshold, etc.). The health indicator 504 is illustrative, and other graphical representations (e.g., shapes, layouts, heatmaps, etc.) may be used.

The user interface 500 further includes data plots 508 and 510 that summarize physiological data associated with each of the patients. For example, data plot 508 corresponds to average blood glucose levels for each patient, and data plot 510 corresponds to triglycerides measurements for each patient. For each of data plots 508 and 510, the data may be a snapshot of most recently received data and may be updated in response to a refresh request. The data may also be updated in real-time. In some implementations, the data plots 508 and 510 may be scaled automatically or re-scaled automatically (e.g., in real-time) in order to help the user easily visualize the data as it is received and changes. In some implementations, each of data plots 508 or 510 show data for each patient at any given time. In other implementations, the user may select a subset of patients (e.g., from the list of patients 506), and in response each of the data plots 508 or 510 will be updated to show only the data corresponding to the selected subset of patients. In some implementations, each of the data plots 508 or 510 will only show data corresponding to those patients appearing in the search window 502. These implementations are illustrative, as other methods of visualizing patient data may be appreciated by one of ordinary skill in the art.

The data plots 508 and 510 appear to be truncated, which indicates that additional data may be hidden. The user may use a suitable input device to cause the layout to shift and display the missing data (e.g., by “scrolling”). Other data plots may also be viewable in the user interface 500, and may be located beneath the data plots 508 and 510. In some implementations, the user may be able to manually adjust the layout of components in the user interface 500. For example, components may be added, removed, resized, and translated. In some implementations, one or more components may be organized within the user interface 500 automatically. For example, if an alert is generated in response to a clinician-defined rule associated with a patient's heart rate, data plot 508 may be replaced with a data plot corresponding to heart rate for one or more of the patients. In some implementations, additional visual indicators may be utilized to draw the user's attention to the patient associated with the generated alert. For example, if the alert was generated in response to patient George Kingsland's heart rate dropping below a threshold amount, a visual indication may appear over or in the vicinity of George Kingsland's name on one or more locations in the user interface 500 (e.g., highlighting, a bounding box, a change in color, an animation, etc.).

FIG. 5B shows an illustrative user interface 550 for accessing and reviewing patient data for a specific patient according to some implementations. For example, the user interface 550 may correspond to the patient details 418 of the sitemap described with respect to FIG. 4. The user interface 550 may be implemented, for example, on a device operated by a user (e.g., a clinician), and may be presented, for example, in response to a selection of one of the contacts/patients listed in the user interface 500 (e.g., in response to a selection of “George Kingsland” from the contact list 506). In some implementations, the user interface 550 may be automatically presented for a particular contact/patient in response to receiving alert data associated with the patient so as to draw the user's attention to the patient's vitals in the event of a potentially harmful physiological condition.

As illustrated, the user interface 550 includes a patient summary panel 552, which includes a portrait 554 of the patient and an electrocardiogram (EKG) 556. The user interface also includes vitals indicators 558, which may display physiological data received in real-time. In some implementations, additional vitals indicators and/or less than all of the vitals indicators 558 shown may be present. For example, the user interface 550 may display vitals indicators only for currently monitored physiological data (e.g., if the user is only having his/her heart rate and blood pressure monitored, only vitals indicators for heart rate and blood pressure may be displayed). In some implementations, displayed vitals indicators 558 may visually distinguish between data received in real-time (e.g., by displaying with white text) and data not received in real-time or not received at all (e.g., by displaying with gray text, by displaying “N/A” in place of a number, etc.). For example, if updated data is not received for a pre-determined amount of time (e.g., 30 seconds, 60 seconds, etc.), a visual indication may be displayed to indicate to the user that real-time data is not being received or is unavailable. In some implementations, detailed biometric data 564 is also displayed, which may include biometric data captured at various points in time. In some implementations, the user may exit the user interface 550 by selecting back option 570, which may cause the application to return to the dashboard display (e.g., the user interface 500).

The user interface 550 may also include a three-dimensional (3D) representation 560 of the patient. The 3D representation may display different interior views of the patient's body. For example, an outermost view may display a representation of an exterior of the patient's body, an inner level view may display a representation of the patient's muscular system, another inner level view may display representations of one or more of the patient's internal organs, and an innermost view may display a representation of the user's skeletal system. Various combinations of views may be utilized including, but not limited to, combined views and cutaway views. The 3D representation 560 may be adjustable by the user using a suitable input device, and may be rotated, scaled, or translated. In some implementations, a two-dimensional (2D) representation may be utilized instead of a 3D representation.

The 3D representation 560 may include one or more alert indicators 562 to draw the user's attention to a part of the patient's body that is experiencing an adverse physiological condition. For example, the patient's heart rate may drop below a threshold specified by a clinician-defined rule (e.g., to generate an alert when the patient's heart rate drops below 45 bpm). Since this biometric parameter is associated with the patient's heart, the alert indicator 562 may be positioned with respect to the patient's heart in order to draw attention thereto. As another example, if an alert is generated in response to an increase in the patient's body temperature above a threshold level, an alert indicator may be in a form of a change in color of the 3D representation 560 (e.g., the patient's skin, skeletal system, or organs may be displayed with a reddish hue, which may vary in intensity as a function of the patient's temperature).

In some implementations, if an alert was generated that is related to one or more parameters that are not easily visualizable or associated with a particular part of the body (e.g., a blood glucose level), an alert indicator may be generated near the 3D representation 560 but may not include an visual indicator to draw attention to a particular part of the body. In some implementations, physical symptoms experienced by the patient that are not easily represented with biometric data may be indicated using the 3D representation 560. For example, the patient may have indicated a physical symptom using a device (e.g., user system 12), which may have been indicated by the user entering text describing the symptom, by voice processing (e.g., the user stating that a part of his/her body is in pain), by a physical motion of the user (e.g., a motion sensing device may detect that the user is holding onto a part of his/her body that is in pain), or by any other suitable method. The host database system (e.g., application server 100) may transmit this information to the device implementing the user interface 550, which may cause an alert indicator to be displayed at the relevant location of the user's body in the 3D representation 560. In some implementations, biometric data at or around a time of the indication of the indication of the physical symptom may be transmitted to the device implementing the user interface 550.

The user interface 550 also includes new alert rule option 566 and new case option 568. The new alert rule option 566 may allow the user (e.g., clinician) to create alert rules that are triggered by one or more of the patient's biometric parameters, as is described below with respect to FIG. 5C. Selection of the new case option 568 may generate an interface that allows the clinician to create or modify a case (e.g., a physiological record) based on received alert data. The options 566 and 568 are illustrative, and additional options may also be available in the user interface 550, such as options to manage existing rules, cases, patient personal information, data management, etc.

FIG. 5C shows an illustrative user interface 575 for creating rules for generating alerts according to some implementations. The user interface includes a rule window 576 that can show existing rules defined by a clinician or group of clinicians. The rule window 576 can include tabs to select between previously defined rules (e.g., “Rule #1”, “Rule #2”, and “Rule #3”). As an example, “Rule #1” is the currently selected rule that can be edited by the clinician. The rule window 576 may include a patient identifier 577 (e.g., a name of the patient), a portrait 578 of the patient, and a rule identifier 579 for the current rule (e.g., 579). The clinician may rename the rule by selecting rename option 580, which may open a window to allow the clinician to enter the new name. In some implementations, each of the rules may apply to the same patient (e.g., George Kingsland). In some implementations, each of the rules may apply to various patients. In some implementations, the same rule may be applied to different patients.

The rule window 576 also includes options 581A-581B as mutually-exclusive radio buttons. If option 581A is selected, the alert is transmitted to the clinician only (e.g., any clinicians associated with the patient) when the alert is triggered by the biometric data. If option 581B is selected, the alert is transmitted to both the clinician and the associated patient (e.g., George Kingsland may receive an alert message on his mobile device).

The rule can be modified to include various conditional statements that generate an alert when satisfied by the biometric data. Parameter options 582 and 588 may be selected from a pre-defined list of biometric parameters, as described previously. Conditional options 583 and 589 may be selected from a pre-defined list of conditions such as “Is greater than”, “Is less than”, “Is equal to”, “Is greater than or equal to”, or any other conditional statement as would be appreciated by one of ordinary skill in the art. In some implementations, other conditional options may be available, such as options that a particular biometric parameter has been maintained within a specified range for a specified period of time. Value boxes 584 and 590 allow for numerical values to be entered for completing the various conditional statements. The appropriate units for the numerical values may be selected depending on whichever parameters have been selected in the parameter options 582 and 588, and may be displayed in some implementations. As illustrated in FIG. 5C, the rule window 576 shows two conditional statements: “Heart rate is greater than 90” and “Blood glucose is less than 50”.

The conditional statements may be linked together by a logical operator. Operator option 586 may be selected from a pre-defined list of logical operators such as “AND”, “OR”, “NOT”, or any other logical operator as would be appreciated by one of ordinary skill in the art. As illustrated in FIG. 5C, the rule window 576 defines a rule that generates an alert when the two aforementioned conditional statements are both satisfied by the biometric data at the same time.

Conditional statements and logical operators may be added or removed as desired by the clinician. For example, removal options 585, 587, and 591 may remove various options associated with a respective conditional statement or logical operator (e.g., selection of removal option 585 may either remove parameter option 582, conditional option 583, and value option 584, or revert them to default values). Additional conditional statements and logical operators may be added by selecting add condition option 592 and add operator option 593, respectively. Delete option 594 may be selected to delete the current rule. Import option 595 may open up a window for selecting a previously define rule from which conditional statements and logical operators can be imported into the currently selected rule. Save option 596 may be selected to save the current rule (e.g., in the system database 24). In some implementations, the clinician may exit the user interface 575 by selecting back option 597, which may cause the application to return to an earlier display (e.g., the user interface 550). It is noted that the user interface 575 provides an illustrative interface for allowing a clinician to define rules for generating alerts, and that other options may also be included in addition to those shown.

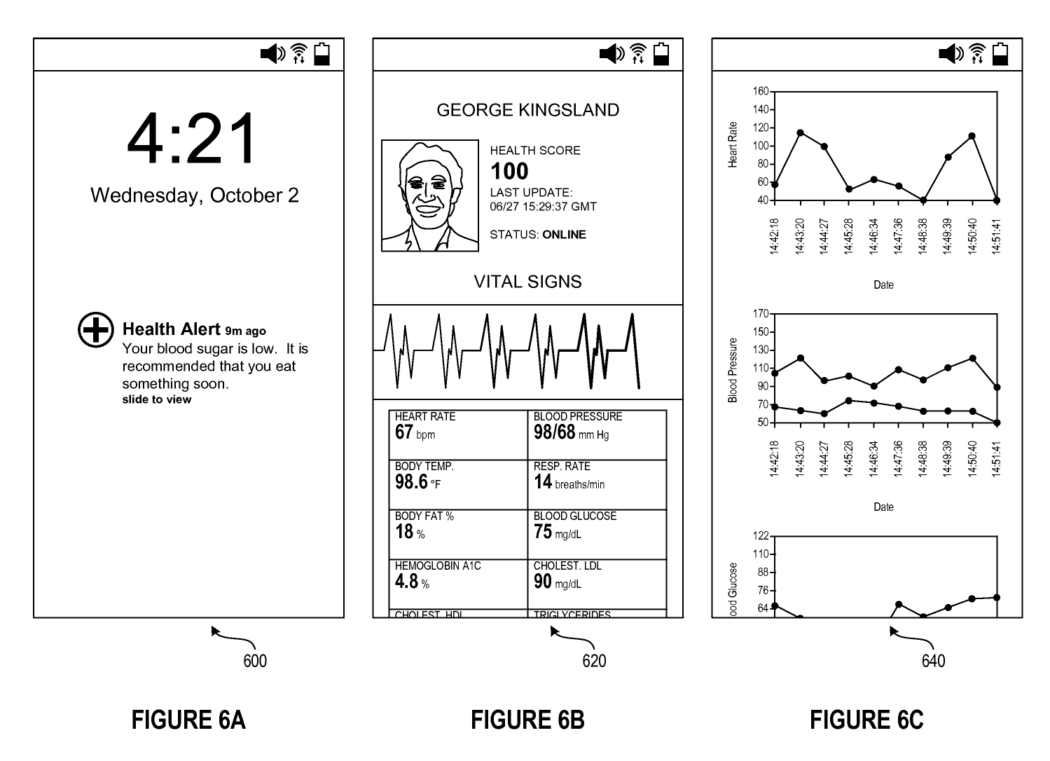

FIGS. 6A-6C show illustrative user interfaces for a viewing monitored biometric data at a portable device according to some implementations. For example, the portable device may be a portable device operated by a patient so that the patient can receive alerts and medical information related to his/her biometric parameters. In some implementations, the portable device may be a portable device operated by a clinician, which may provide a greater range of options for viewing data, configuring alerts, and generating messages for transmission to a patient's device.

FIG. 6A shows a user interface 600 that displays a health alert for a patient. The health alert may correspond to a case defined or modified by a clinician associated with the patient. For example, the clinician may have defined a rule (e.g., using the user interface 575 implemented on a device of the clinician) for generating an alert when the patient's blood glucose level drops below a threshold value. In some implementations, the alert is transmitted to the clinician only, and the clinician may define or modify a case for the patient relating to the patient's current or pre-existing condition. The case may include information pertaining to the patient's condition (e.g., a message recommending that the patient eats). The clinician may then request to have the information from the case transmitted to the device of the patient. In some implementations, the alert or case information may automatically be transmitted to the device of the patient. For example, the clinician may define in the rule a request to transmit the alert to the user when the alert is triggered by the biometric data. In some implementations, the alert may be transmitted along with information from the patient's case, such as a message associated with the alert (e.g., the message recommending that the patient eats).

FIGS. 6B and 6C show user interfaces 620 and 640, respectively, that may be used to provide the patient with an overview of his/her vitals. For example, the components contained in the user interfaces 620 and 640 are similar to those of the user interface 550 except with a reduced set of options (e.g., options specific to a role of the clinician).

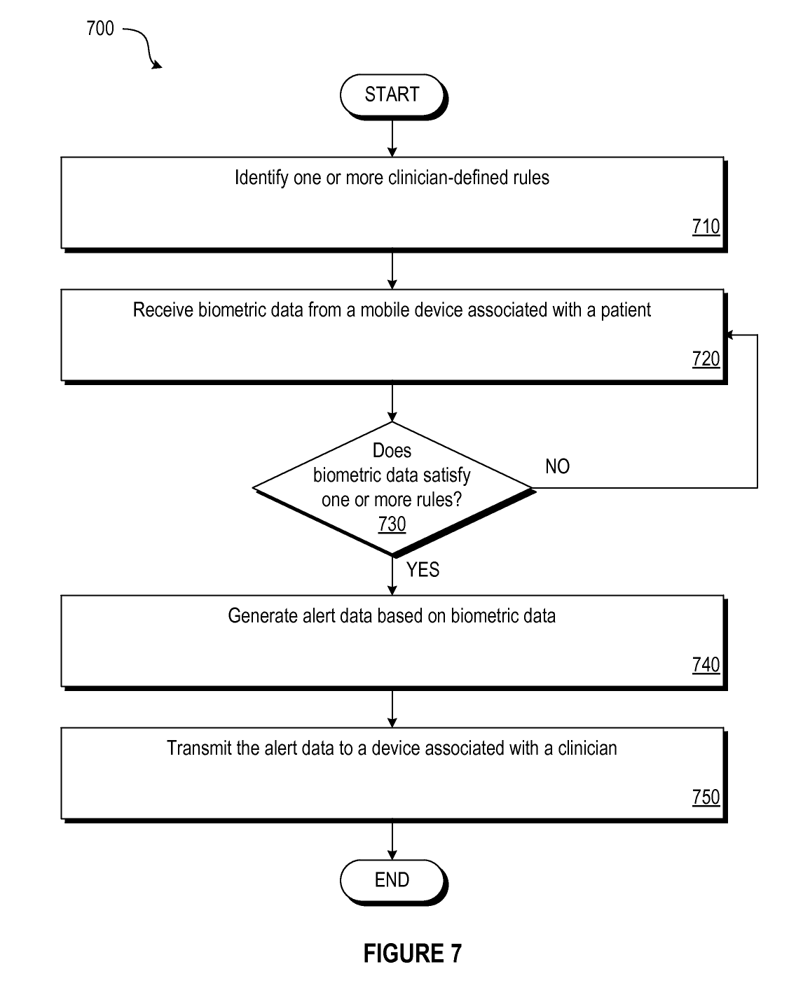

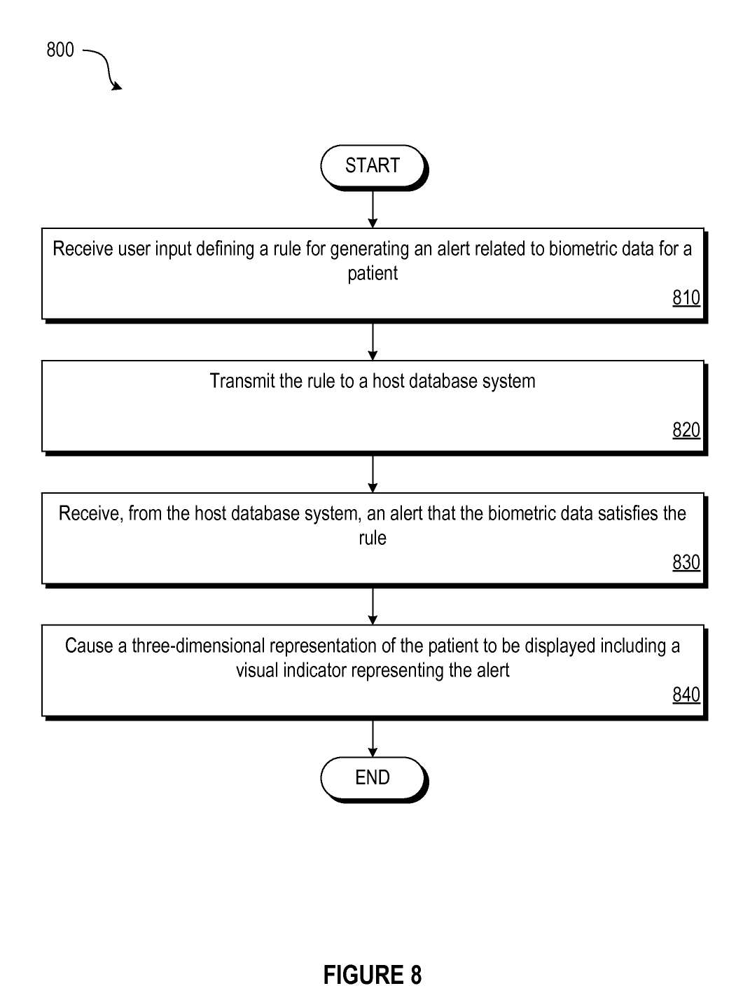

FIG. 7 is a flow diagram illustrating a method 700 for real-time biometric monitoring and alert generation according to some implementations. FIG. 8 is a flow diagram illustrating a method 800 for defining rules and processing alert data according to some implementations. The methods 700 and 800 may be performed by processing logic comprising hardware (e.g., circuitry, dedicated logic, programmable logic, microcode, etc.), software (such as instructions run on a processing device), or a combination thereof. In one implementation, the method 700 may be performed by one or more processing components associated with a host database system (e.g., implemented on the application server 100). In one implementation, the method 800 may be performed by one or more processing components associated with a device operated by a clinician (e.g., implemented by a user system 12).

Referring now to FIG. 7, at block 710, one or more clinician-defined rules are identified. For example, the clinician-defined rules may be received by the application server 100 and stored in tenant data storage 22 as a data structure associated with a patient. The one or more clinician-defined rules may have been defined by a clinician using, for example, the user interface 575 implemented on a device associated with the clinician (e.g., one of the user systems 12). The rules may have been defined with respect to one or more patients associated with the clinician. In some implementations, the device associated with the clinician is a mobile device.

At block 720, biometric data is received from a mobile device associated with a patient. The mobile device may correspond to one of the user systems 12, and may be capable measuring and/or collecting data related to one or more physiological parameters of the user. For example, the mobile device may be adapted to measure the patient's heart rate in real-time, and transmit the measured heart rate data to the host database system for storage (e.g., in the tenant data storage 22). In some implementations, the mobile device is configured for voice recognition, speech processing, and/or motion sensing. In some implementations, the biometric data includes data related to one or more of blood pressure, blood glucose, body temperature, heart rate, respiratory rate, body composition, hemoglobin, cholesterol, triglycerides, an EKG, or a computed health score.

At block 730, a determination is made as to whether the received biometric data satisfies one or more of the clinician-defined rules. In some implementations, a portion of the data may be analyzed based on the rule. The portion may correspond to data associated with one or more physiological parameters specified in the rule, data received within a specified period of time, or combinations thereof. In one implementation, the rule includes a first conditional statement associated with a first biometric parameter, a second conditional statement associated with a second biometric parameter, or more conditional statements. For example, one or more of the conditional statements may include a threshold condition. In some implementations, the first and second conditional statements are joined via a logical operator (e.g., “AND”, “OR”, etc.). In some implementations, determining that a portion of the biometric data satisfies the rule comprises determining that the portion of the biometric data satisfies a threshold condition associated with the biometric parameter.

If a determination is made that the received biometric data satisfies one or more of the clinician-defined rules, the method 700 proceeds to block 740, otherwise the method may proceed to block 720 where additional biometric data is received by the host database system until a rule is determined to be satisfied. At block 740, alert data is generated based on the biometric data. In one implementation the alert data includes an indication of a symptom of a patient. In one implementation, the alert data includes an indication of a part of the patient's body associated with the clinician-defined rule. In one implementation, the alert data includes an indication of a symptom of the patient. In one implementation, the alert data includes the portion of the biometric data that was determined to have satisfied the clinician-defined rule.

At block 750, the alert data is transmitted to the device associated with the clinician. In one implementation, a physiological record (e.g., a case) is generated in response to a request received from a device of the clinician, and the physiological record may be based at least partially on the alert data. In one implementation, the physiological record is received by the host database base system. For example, the physiological record may have been generated at the device of the clinician after the clinician has received and reviewed the alert data. In one implementation, confirmation is received from the device of the clinician to transmit an alert-related message to the mobile device of the patient, and, in response, the alert-related message to the mobile device. For example, the alert-related message may correspond to information included in the physiological record. In one implementation, a determination is made as to whether the clinician-defined rule includes an instruction to transmit an indication of the alert data to the mobile device of the patient (e.g., option 581B). If the clinician-defined rule includes the instruction, the indication of the alert data is transmitted to the mobile device of the patient.

The method 700 ends after block 740. In some implementations, the method 700 may repeat continuously, starting from any block within the method 700. For example, if the clinician defines a new rule, the method 700 may begin from block 710.

Referring now to FIG. 8, at block 810, user input is received, with the user input defining a rule (e.g., a clinician-defined rule) for generating an alert related to biometric data for a patient. In some implementations, the rule is defined by a clinician using the user interface 575 implemented on a device (e.g., one of the user systems 12). At block 820, the rule is transmitted to a host database system for storage (e.g., storage in the tenant database 22 of the application server 100).

At block 830, an alert is received from the host database system, the alert indicating that the biometric data (or at least a portion thereof) satisfies the clinician-defined rule. At block 840, a three-dimensional representation of the patient is displayed (e.g., 3D representation 560), which includes a visual indicator representing the alert (e.g., alert indicator 562). In some implementations, biometric data may also be displayed together with the 3D representation 560. For example, the EKG 556, vitals indicators 558, and detailed biometric data 564 may be displayed. In some implementations, biometric data associated with the alert may be displayed while biometric data not associated with the alert may be prevented from being displayed, so as to draw the clinician's attention to the alert-relevant biometric information.

The specific details of the specific aspects of implementations disclosed herein may be combined in any suitable manner without departing from the spirit and scope of the disclosed implementations. However, other implementations may be directed to specific implementations relating to each individual aspect, or specific combinations of these individual aspects. Additionally, while the disclosed examples are often described herein with reference to an implementation in which an on-demand database service environment is implemented in a system having an application server providing a front end for an on-demand database service capable of supporting multiple tenants, the present implementations are not limited to multi-tenant databases or deployment on application servers. Implementations may be practiced using other database architectures, i.e., ORACLE®, DB2® by IBM and the like without departing from the scope of the implementations claimed. Moreover, the implementations are applicable to other systems and environments including, but not limited to, client-server models, mobile technology and devices, wearable devices, and on-demand services.

It should also be understood that some of the disclosed implementations can be embodied in the form of various types of hardware, software, firmware, or combinations thereof, including in the form of control logic, and using such hardware or software in a modular or integrated manner. Other ways or methods are possible using hardware and a combination of hardware and software. Additionally, any of the software components or functions described in this application can be implemented as software code to be executed by one or more processors using any suitable computer language such as, for example, Java, C++ or Perl using, for example, existing or object-oriented techniques. The software code can be stored as a computer-or processor-executable instructions or commands on a physical non-transitory computer-readable medium. Examples of suitable media include random access memory (RAM), read only memory (ROM), magnetic media such as a hard-drive or a floppy disk, or an optical medium such as a compact disk (CD) or DVD (digital versatile disk), flash memory, and the like, or any combination of such storage or transmission devices. Computer-readable media encoded with the software/program code may be packaged with a compatible device or provided separately from other devices (for example, via Internet download). Any such computer-readable medium may reside on or within a single computing device or an entire computer system, and may be among other computer-readable media within a system or network. A computer system, or other computing device, may include a monitor, printer, or other suitable display for providing any of the results mentioned herein to a user.

While some implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

What is claimed is:

1. A computer-implemented method, the method comprising:
receiving, at a host database system, biometric data from a mobile device associated with a patient;
identifying, by the host database system, a rule defined by a clinician;
generating, by the host database system, alert data corresponding to a portion of the biometric data in response to determining that the portion of the biometric data satisfies the rule; and
transmitting, by the host database system, the alert data to a device associated with the clinician.

2. The method of claim 1, further comprising:
generating a physiological record associated with the patient in response to a request received from a device of the clinician, wherein the physiological record is generated based at least partially on the alert data.

3. The method of claim 1, further comprising:
receiving confirmation from a device of the clinician to transmit an alert-related message to the mobile device; and
transmitting the alert-related message to the mobile device.

4. The method of claim 1, wherein the portion of the biometric data is associated with a biometric parameter, and wherein determining that a portion of the biometric data satisfies the rule comprises determining that the portion of the biometric data satisfies a threshold condition associated with the biometric parameter.

5. The method of claim 1, wherein the rule comprises a first conditional statement associated with a first biometric parameter.

6. The method of claim 5, wherein the first conditional statement comprises a threshold condition.

7. The method of claim 5, wherein the rule comprises a second conditional statement associated with a second biometric parameter, and wherein the first and second conditional statements are joined via a logical operator.

8. The method of claim 1, further comprising:
receiving, by the host database system, the rule from a device associated with the clinician; and
storing, by the host database system, the rule in a data structure associated with the patient.

9. The method of claim 1, further comprising:
determining that the rule comprises an instruction to transmit an indication of the alert data to the mobile device of the patient; and
transmitting the indication of the alert data to the mobile device of the patient.

10. The method of claim 1, wherein the mobile device of the patient is a device adapted to collect data corresponding to one or more physiological parameter of the patient.

11. The method of claim 1, wherein a device of the clinician is to generate a three-dimensional representation based at least partially on the alert data.

12. The method of claim 1, wherein the biometric data comprises one or more of blood pressure data, blood glucose data, body temperature data, heart rate data, respiratory rate data, body composition data, hemoglobin data, cholesterol data, triglycerides data, electrocardiogram data, or computed health score data.

13. A database system, comprising:
a processing system; and
a memory device coupled to the processing system, the memory device having instructions stored thereon that, in response to execution by the processing system, cause the processing system to perform operations comprising:
receiving biometric data from a mobile device associated with a patient;
identifying a rule defined by a clinician;
generating alert data corresponding to a portion of the biometric data in response to determining that the portion of the biometric data satisfies the rule; and
transmitting the alert data to a device associated with the clinician.

14. The database system of claim 13, wherein the operations further comprise:
generating a physiological record associated with the patient in response to a request received from a device of the clinician, wherein the physiological record is generated based at least partially on the alert data.

15. The database system of claim 13, wherein the operations further comprise:
receiving confirmation from a device of the clinician to transmit an alert-related message to the mobile device; and
transmitting the alert-related message to the mobile device.

16. The database system of claim 13, wherein the portion of the biometric data is associated with a biometric parameter, wherein determining that a portion of the biometric data satisfies the rule comprises determining that the portion of the biometric data satisfies a threshold condition associated with the biometric parameter, and wherein the biometric data comprises one or more of blood pressure data, blood glucose data, body temperature data, heart rate data, respiratory rate data, body composition data, hemoglobin data, cholesterol data, triglycerides data, electrocardiogram data, or computed health score data.

17. The database system of claim 13, wherein the rule comprises a first conditional statement associated with a first biometric parameter, wherein the rule comprises a second conditional statement associated with a second biometric parameter, and wherein the first and second conditional statements are joined via a logical operator.

18. The database system of claim 13, wherein the operations further comprise:
receiving the rule from a device associated with the clinician; and
storing the rule in a data structure associated with the patient.

19. The database system of claim 13, wherein the operations further comprise:
determining that the rule comprises an instruction to transmit an indication of the alert data to the device of the patient; and
transmitting the indication of the alert data to the device of the patient.

20. A non-transitory computer-readable medium having instructions encoded thereon which, when executed by a processing system, cause the processing system to perform operations comprising:
receiving biometric data from a mobile device associated with a patient;
identifying a rule defined by a clinician;
generating alert data corresponding to a portion of the biometric data in response to determining that the portion of the biometric data satisfies the rule; and
transmitting the alert data to a device associated with the clinician.
